(19) United States
(12) Patent Application Publication
(10) Pub. No.: US 2013/0050431 A1
(43) Pub. Date: Feb. 28, 2013

(54) METHOD OF OBSERVING CROSS-SECTION OF COSMETIC MATERIAL

(71) Applicants: Norinobu YOSHIKAWA, Kanagawa (JP); Kaori Ikuta, Kanagawa (JP)

(72) Inventors: Norinobu YOSHIKAWA, Kanagawa (JP); Kaori Ikuta, Kanagawa (JP)

(73) Assignee: SHISEIDO COMPANY, LTD., Tokyo (JP)

(21) Appl. No.: 13/585,980

(22) Filed: Aug. 15, 2012

(30) Foreign Application Priority Data
Aug. 29, 2011 (JP) 2011-186537

(51) Int. Cl. H04N 7/18; H04N 13/02

(52) U.S. Cl. 348/46; 348/80; 348/E07.085; 348/E13.074

(57) ABSTRACT

A method of observing a cross-section of a cosmetic material includes a sample forming step of forming a sample by providing a cosmetic material on a sample holder; a freezing step of freezing the sample; a cutting step of forming a cut surface on the sample by processing the frozen sample by a focused ion beam; and a cut surface image processing step of obtaining a cut surface image of the cut surface using a scanning electron microscope.

### BACKGROUND OF THE INVENTION

1. Field of the Invention

The present invention relates to a method of observing a cross-section of a cosmetic material.

2. Description of the Related Art

Generally, when developing a cosmetic material, the cosmetic material is evaluated by observing the cosmetic material in a coated condition on a skin. For the method of observing the coated cosmetic material, a method of observing the surface of the coated cosmetic material from outside is used.

However, with this method, inside of the coated cosmetic material cannot be observed. Thus, it is not possible to detect a condition of a preparation included in the cosmetic material inside the coated cosmetic material, so that a contribution of the method is not enough for the development of the cosmetic material.

Thus, a method of observing a cross-section of the coated cosmetic material has been widely used. Patent Document 1 discloses an example of the method of observing the cross-section. According to the method of observing the cross-section disclosed in Patent Document 1, a cosmetic material film is formed on a surface of a support member, and the cosmetic material film is cut (or cross sectioned) with the support member after the cosmetic material film and the support member are frozen to form a cross-section for observation. Then, the cross-section for observation is observed by a microscope.

However, by the method of observing disclosed in Patent Document 1, when cutting the cosmetic material film, both sides of a portion to be observed are clamped by forceps, and then the cosmetic material film is cut with the support member by applying a bending stress to form the cross-section for observation. Thus, there is a case where a cross-section of a desired portion cannot be obtained and observation of a desired condition of the cosmetic material (preparation) cannot be conducted. Further, according to the conventional method, only one cross-section is obtained from one sample and a three-dimensional image (3D image) of a preparation in the cosmetic material cannot be obtained. Therefore, it is difficult to clearly observe the preparation.

### PATENT DOCUMENT

[Patent Document 1] Japanese Laid-open Patent Publication No. 2005-084005

### SUMMARY OF THE INVENTION

The present invention is made in light of the above problems, and provides a method of observing a cross-section of a cosmetic material at a desired portion.

According to an embodiment, there is provided a method of observing a cross-section of a cosmetic material, including a sample forming step of forming a sample by providing a cosmetic material on a sample holder; a freezing step of freezing the sample; a cutting step of forming a cut surface on the sample by processing the frozen sample by a focused ion beam; and a cut surface image processing step of obtaining a cut surface image of the cut surface using a scanning electron microscope.

### BRIEF DESCRIPTION OF THE DRAWINGS

Other objects, features and advantages of the present invention will become more apparent from the following detailed description when read in conjunction with the accompanying drawings.

FIG. 1 is a flowchart for explaining a method of observing a cross-section of a cosmetic material of an embodiment;

FIG. 2 is a schematic view for explaining a sample forming step;

FIG. 3 is a schematic view for explaining a freezing step;

FIG. 4 is a schematic view for explaining a freezing step;

FIG. 5 is a schematic view for explaining a shielding process;

FIG. 6 is a block diagram schematically showing an example of a structure of a FIB-SEM;

FIG. 7 is a schematic view showing a portion of a sample where a focused ion beam is irradiated;

FIG. 8A is a schematic view showing a portion of a sample where a focused ion beam is irradiated;

FIG. 8B is a schematic view showing a portion of a sample where an electron beam is irradiated;

FIG. 9A and FIG. 9B are cross-sectional views of a sample for explaining a cutting step;

FIG. 10 is a schematic view for explaining an image processing step;

FIG. 11 is a view showing an example of a three-dimensional image formed in an image processing step;

FIG. 12A is a view showing a cut surface image obtained by cutting a sample using a focused ion beam by a FIB apparatus;

FIG. 12B is a view showing a cut surface image obtained by cutting a sample using a blade;

FIG. 13 is a view for explaining cut surface images of a preparation including emulsified particles;

FIG. 14 is a three-dimensional image obtained based on the cut surface images shown in FIG. 13;

FIG. 15 is a view showing conditions used in each steps; and

FIG. 16 is a view showing a relationship between a pitch for a cutting portion, irradiation time and a beam current value of a focused ion beam.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

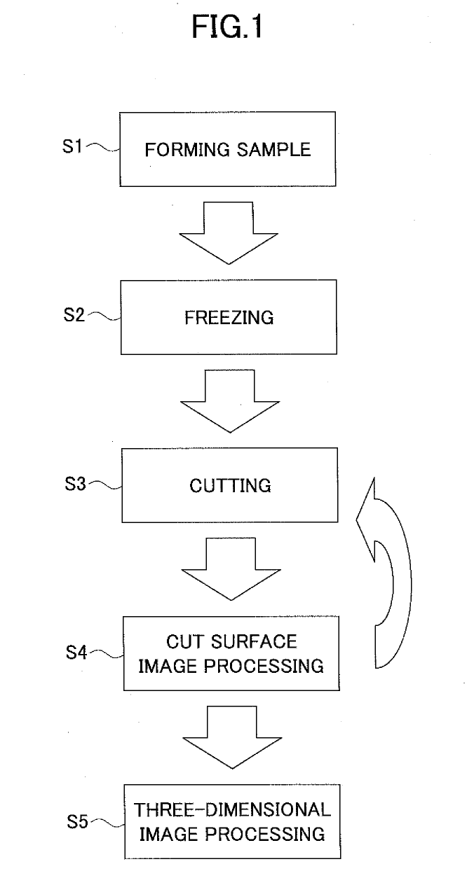

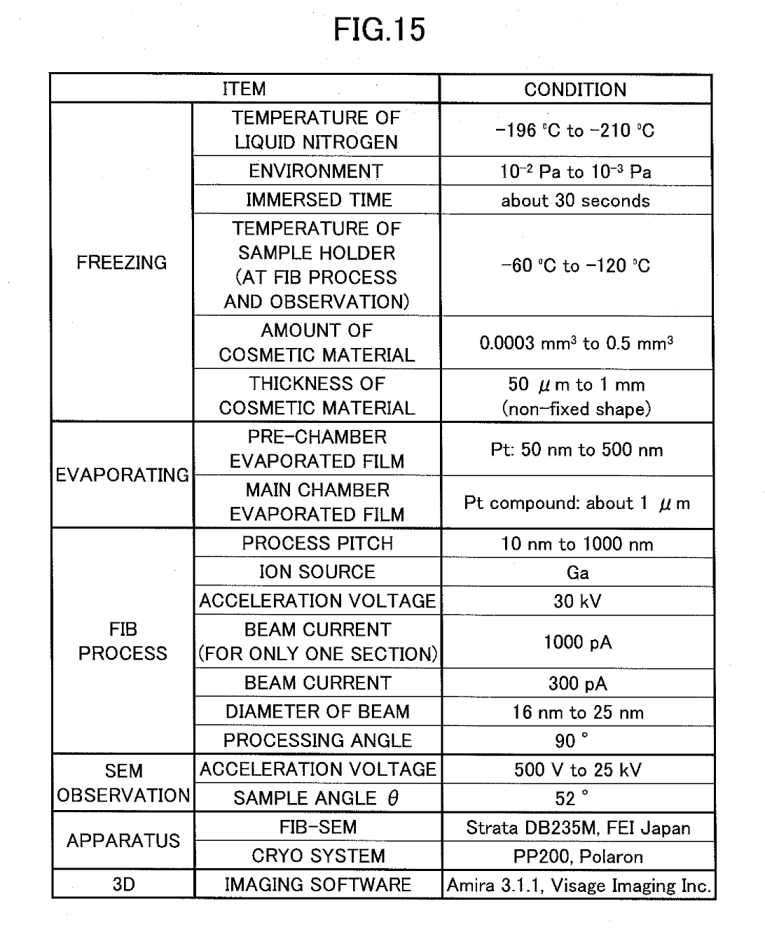

FIG. 1 to FIG. 11 are views for explaining an example of a method of observing a cross-section of a cosmetic material according to the embodiment. FIG. 15 shows an example of conditions for the method of observing a cross-section of a cosmetic material according to the embodiment.

In the method of observing a cross-section of a cosmetic material of the embodiment, a cross-section of a cosmetic material placed on a sample holder, which functions as a fulcrum, is observed.

FIG. 1 is a flowchart for explaining the method of observing a cross-section of a cosmetic material of the embodiment.

The method of observing a cross-section of a cosmetic material of the embodiment includes;

a sample forming step of forming a sample 1 by placing a cosmetic material 9 on a sample holder 10 (S1),

a freezing step of freezing the sample 1 (S2),
a cutting step of cutting the frozen sample 1 by a focused ion beam 4a to form a cut surface at the sample 1 (S3),
a cut surface image processing step of forming a cut surface image of the cut surface using a scanning electron microscope (simply referred to as “SEM” hereinafter) (S4), and
a three-dimensional image processing step of forming a three-dimensional image based on plural of the cut surface images (S5).

Each of the steps is explained in detail in the following.

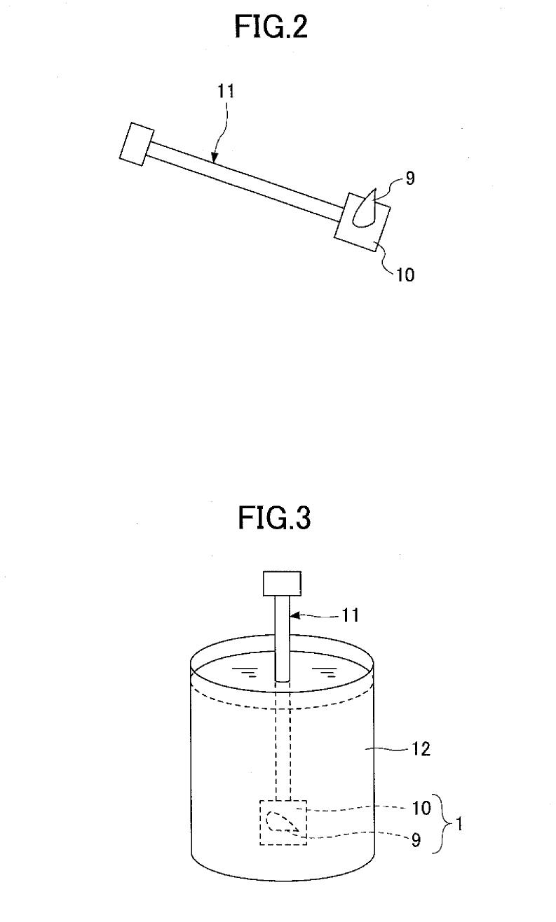

FIG. 2 is a schematic view for explaining the sample forming step S1. In the sample forming step S1, a film of the cosmetic material 9 is formed on the sample holder 10 by coating the cosmetic material 9 at a surface of the sample holder 10.

The amount of the cosmetic material 9 to be coated on the sample holder 10 may be, for example, 0.0003 mm³ to 0.5 mm³. The thickness of the film of the cosmetic material 9 may be for example, more than or equal to 50 μm and less than or equal to 1 mm (see FIG. 15). However, these values are just an example and the shape of the cosmetic material 9 formed on the sample holder 10 may not be specifically limited.

The cosmetic material 9 may be selected from cosmetic materials having various properties such as in liquid form, in gel form, plastic or the like. The cosmetic material 9 may be selected from various kinds of cosmetic materials such as milky lotion, lotion, foundation, sunscreen or the like. However, the cosmetic material 9 applicable in the embodiment may not be specifically limited.

Further, although a material for the sample holder 10 on which the cosmetic material 9 is placed is not specifically limited, the sample holder 10 may be selected to have a property similar to human skin, for which the cosmetic material 9 is to be actually coated.

Specifically, artificial skin, a transfer member, or a skin fragment may be used as the sample holder 10. The artificial skin is a simulation of skin, and may be, for example, made of PMMA (poly-methyl methacrylate), urethane, nylon (registered trademark) or the like.

For a case when the sample holder 10 is the transfer member, the transfer member has a structure including a base member such as glass, resin tape or the like and a viscosity member coated on the base member. In this case, the sample holder 10 is used after being applied to skin and removed from the skin so that a status of the skin is transferred onto the viscosity member.

The sample holder 10 is provided and attached at an end of a jig 11. The jig 11 may be in a stick shape. The jig 11 is used for supporting the sample holder 10 when the sample holder 10 and the cosmetic material 9 are immersed into a refrigerant container 12 in the freezing step S2, and when the sample 1 is provided in a chamber 3 in the cutting step S3, which will be explained later.

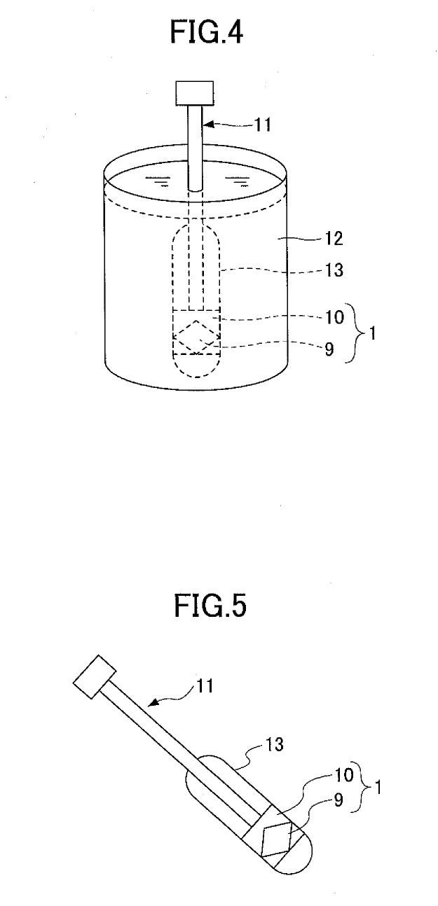

As described above, when the cosmetic material 9 is placed on the sample holder 10, subsequently, the freezing step S2 is performed. FIG. 3 and FIG. 4 are schematic views for explaining the freezing step S2. In this embodiment, liquid nitrogen is used as a refrigerant to freeze the cosmetic material 9.

As shown in FIG. 3, the liquid nitrogen is contained in the refrigerant container 12. The cosmetic material 9 and the sample holder 10 attached at the end of the jig 11 are input into the refrigerant container 12 to be immersed in the liquid nitrogen.

At this time, the temperature of the liquid nitrogen is within a range between −196° C. to −210° C., and the pressure (environment) is set within a range between 10⁻² Pa to 10⁻³ Pa. Under this environment, the temperature of the sample holder 10 immersed in the refrigerant container 12 becomes within a range between −60° C. to −120° C. Further, in this embodiment, the cosmetic material 9 and the sample holder 10 are immersed in the liquid nitrogen about 30 seconds (see FIG. 15).

By the freezing step, the cosmetic material 9 and the sample holder 10 are frozen. The frozen cosmetic material 9 and the sample holder 10 are called “sample 1” hereinafter.

When the sample 1 is generated, the sample 1 is shielded with a shielding process. Specifically, the sample 1, which is frozen, is included in a shielding member 13. The shielding member 13 may be made of brass, stainless steel or the like.

By performing the shielding process using the shielding member 13, the sample 1 can be conveyed (so-called in situ) to a subsequent apparatus while maintaining the frozen status without touching the external environment which includes air or the like, so that the atmosphere at the freezing step S2 is maintained. At this time, the shielding member 13 is kept at vacuum pressure, or filled with inert gas.

Next, the cutting step S3 and the cut surface image processing step S4 are performed on the sample 1 (the cosmetic material 9 and the sample holder 10) included in the shielding member 13. The cutting step S3 and the cut surface image processing step S4 are performed using a focused ion beam/scanning electron microscope 20 (simply referred to as a “FIB-SEM 20” hereinafter). The FIB-SEM 20 is configured to have a function of a focused ion beam generating apparatus and a SEM.

The sample 1 shielded with the shielding process is removed from the refrigerant container 12 as shown in FIG. 5, and conveyed to the FIB-SEM 20 in situ.

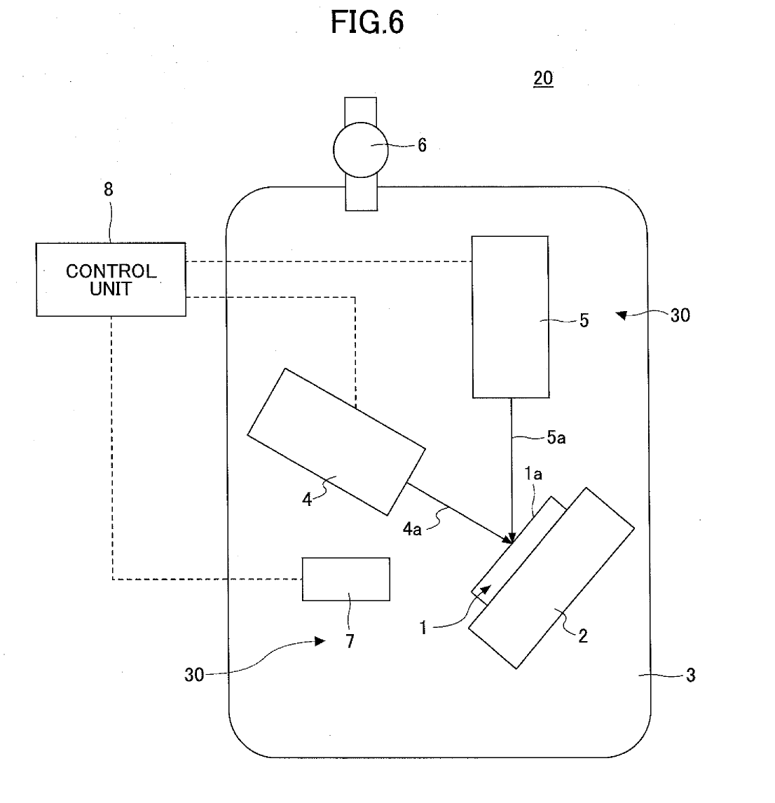

FIG. 6 is a block diagram schematically showing an example of a structure of the FIB-SEM 20. The FIB-SEM 20 is configured to mainly include a temperature adjusting apparatus 2, a chamber 3, a focused ion beam generating apparatus 4, a supply and exhaust device 6, a control unit 8, a SEM 30 and the like. The SEM 30 includes an electron beam generating apparatus 5, an electron detection apparatus 7 and the like.

The temperature adjusting apparatus 2 functions as a mounting table on which the sample 1 is mounted. The sample 1 contained in the shielding member 13 is conveyed to the FIB-SEM 20 in situ to be placed on the temperature adjusting apparatus 2.

The temperature adjusting apparatus 2 functions to keep the temperature of the sample 1 placed on the temperature adjusting apparatus 2 at a set temperature. Specifically, the temperature adjusting apparatus 2 of the embodiment is a cryo system capable of maintaining the sample 1 at a range between −60° C. to −120° C., for example. The temperature adjusting apparatus 2 is provided in the chamber 3. PP200 (manufactured by Polaron) may be used as the temperature adjusting apparatus 2, which is the cryo system (see FIG. 15).

The chamber 3 is a container that isolates its inside from an outside atmosphere, and maintains the inside pressure and the inside environment at a constant status with the function of the supply and exhaust device 6. In this embodiment, the inside of the chamber 3 is maintained at 1×10³ to 1×10⁻⁴ Pa when the cutting step S3 and the cut surface image processing step S4 using the FIB-SEM 20 are performed.

The focused ion beam generating apparatus 4 (simply referred to as a “FIB apparatus 4” hereinafter) is configured to irradiate a focused ion beam 4a toward the sample 1 mounted on the temperature adjusting apparatus 2. The FIB apparatus 4 is configured to irradiate the focused ion beam 4a in a direction substantially perpendicular to a surface la of the sample 1. In other words, the FIB apparatus 4 is configured to irradiate the focused ion beam 4a in a direction substantially perpendicular to a surface of the temperature adjusting apparatus 2. In this embodiment, gallium ions (Ga⁺) are used for an ion source of the FIB apparatus 4.

The FIB apparatus 4 sputters the cosmetic material 9 which is at a surface of the sample 1 by irradiating the focused ion beam 4a on the sample 1. In other words, the FIB apparatus 4 flips atoms of the cosmetic material 9. With this, the cosmetic material 9 is cut (cross sectioned). The diameter of the focused ion beam 4a may be set to a few hundreds nm to a few nm, 16 nm to 25 nm, for example as shown in FIG. 15. Thus, the sample (cosmetic material 9) can be processed in nm order by the FIB apparatus 4.

The electron beam generating apparatus 5 and the electron detection apparatus 7 compose the SEM 30. The SEM 30 includes various devices and apparatuses such as a focusing lens, an objective lens, a scanning coil or the like in addition to the electron beam generating apparatus 5 and the electron detection apparatus 7. However, only the electron beam generating apparatus 5 and the electron detection apparatus 7 are shown in FIG. 6 for explanation.

The electron beam 5a emitted from the electron beam generating apparatus 5 is irradiated on a predetermined position of the sample 1 after being focused by the focusing lens and the objective lens (not shown in the drawings). Further, the thus focused electron beam 5a is scanned on the sample 1 by a function of the scanning coil (not shown in the drawings) of the SEM 30.

By scanning the electron beam 5a on the sample 1, secondary electrons and reflection electrons are generated from the sample 1 on which the electron beam 5a is irradiating. The electron detection apparatus 7 detects the secondary electrons and the reflection electrons. Then, an image of the sample 1 can be obtained by imaging the detection result detected by the electron detection apparatus 7 by the control unit 18.

The control unit 18 may be a computer. The control unit 18 controls the entirety of the FIB-SEM 20 such as the temperature adjusting apparatus 2, the FIB apparatus 4, the SEM 30 and the supply and exhaust device 6. Further, the control unit 18 forms an image of the sample 1 by performing image processing based on detected signals of the secondary electrons and the reflection electrons supplied from the electron detection apparatus 7.

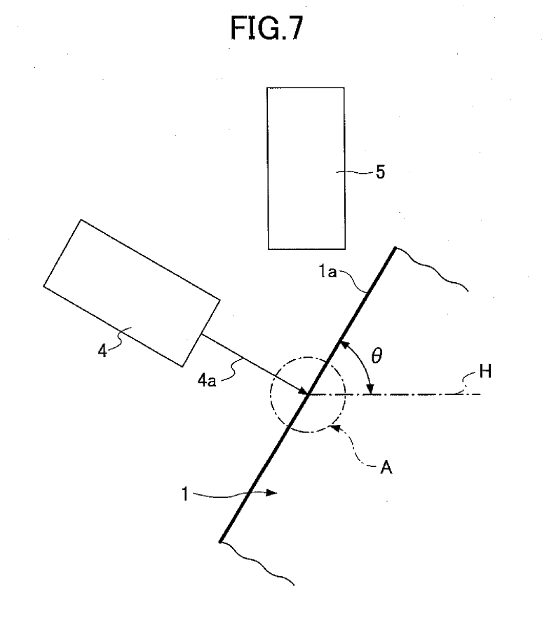

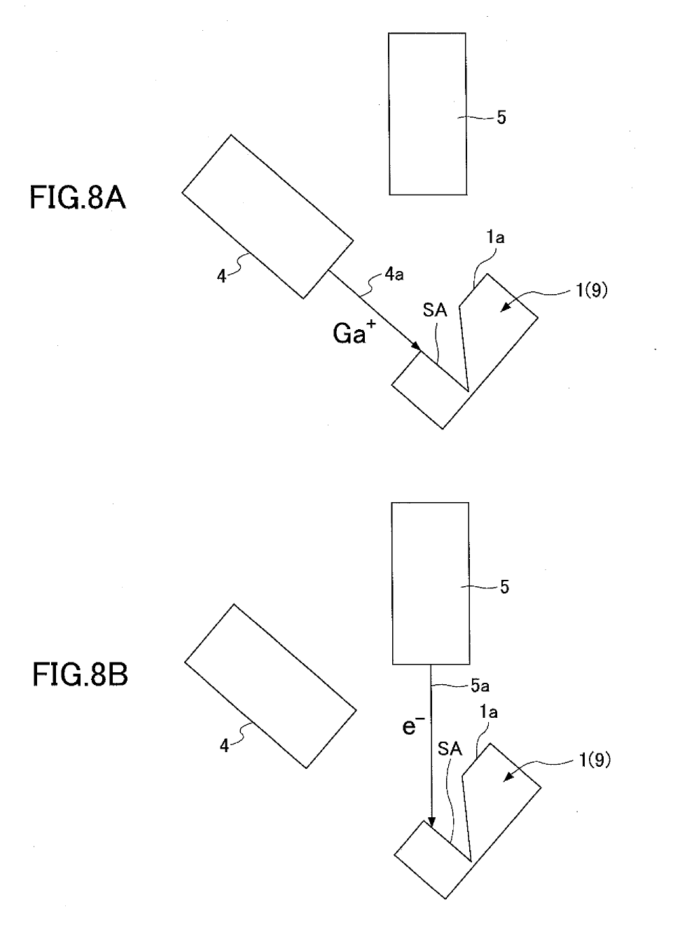

FIG. 7, FIG. 8A and FIG. 8B are schematic views showing a portion of the sample 1 where the focused ion beam 4a and the electron beam 5a are irradiated, in an enlarged manner. The FIB-SEM 20 of the embodiment is configured such that the electron beam generating apparatus 5 emits the electron beam 5a downward in a substantially vertical direction.

Here, as shown in FIG. 7, the sample 1 is provided such that a sample angle 0 between a horizontal line H and the surface la of the sample 1 is set 52°, for example. In other words, the temperature adjusting apparatus 2 is controlled to have the angle θ become the set angle. Further, as described above, the FIB apparatus 4 is configured to irradiate the focused ion beam 4a in a direction substantially perpendicular to the surface 1a of the sample 1.

The FIB apparatus 4 and the electron beam generating apparatus 5 are configured such that the irradiating position of the focused ion beam 4a and the irradiating position of the electron beam 5a are arbitrarily adjustable.

Further, the temperature adjusting apparatus 2 may be rotatably provided such that the angle θ is arbitrarily adjusted in accordance with a desired portion to be observed. For example, a user may adjust the angle θ by controlling the position of the temperature adjusting apparatus 2 via the control unit 8 when observing an image of a cut surface. By adjusting or changing the angle θ, a cut portion can be formed at a desired portion so that a status of the desired portion can be observed.

In the cutting step S3, by irradiating the focused ion beam 4a from the FIB apparatus 4 on the surface 1a of the sample 1, the cosmetic material 9 is cut. As described above, the focused ion beam 4a is irradiated in the direction substantially perpendicular to the surface of the sample 1. Thus, a cut surface SA which is substantially perpendicular to the surface la of the sample 1 is formed in the sample 1 by the process using the FIB apparatus 4, as shown in FIG. 8A.

Further, according to the method of observing a cross-section of a cosmetic material of the embodiment, the cutting step S3 is performed after the freezing step S2 is performed. Thus, the sample 1 is cut under a frozen condition (fixed condition). Therefore, it is possible to cut or process the sample 1 in nm order in the cutting step S3.

However, if the cutting step S3 is performed without freezing the cosmetic material 9, the cosmetic material 9, not frozen, may be liquid or in a viscous status. Thus, even if the focused ion beam 4a is irradiated on the cosmetic material 9 in such a status, an appropriate cut surface of the cosmetic material 9 cannot be obtained.

Further, if the cosmetic material 9, which is frozen in the freezing step S2, is cut by a conventional method such as using a blade or the like in the cutting step S3 instead of using the FIB apparatus 4, it is very difficult to cut the frozen sample 1. Therefore, it is necessary to cut a portion of the frozen sample 1 using the blade or the like with a strong force. Thus, the physical condition of the portion to be cut of the sample 1 may be changed at this time. In this case as well, an appropriate cut surface of the cosmetic material 9 cannot be obtained.

As described above, by freezing the sample 1 in the freezing step S2 and cutting the frozen sample 1 using the FIB apparatus 4 in the cutting step S3, the appropriate cut surface SA of the sample 1 can be obtained in accordance with the method of observing a cross-section of a cosmetic material.

In this embodiment, when the cut surface SA is formed in the cutting step S3 as described above, an evaporating process of forming an evaporated film on the cut surface SA may be performed. The evaporated film may be formed to prevent charging of the sample 1 when measuring the sample 1 by the SEM 30. The evaporated film may be a metal film formed of platinum (Pt) or platinum (Pt) compound. The thickness of the evaporated film may be about 50 nm to 500 nm when the evaporated film is formed in a pre-chamber and may be about 1 μm when the evaporated film is formed in a main chamber, for example (see FIG. 15).

After the evaporated film is formed on the cut surface SA, the SEM 30 is activated in the cut surface image processing step 54 and the electron beam 5a is irradiated from the electron beam generating apparatus 5 on the cut surface SA while scanning the electron beam 5a. Then, the generated secondary electrons and the reflection electrons are detected by the electron detection apparatus 7. FIG. 8B is a schematic view showing a condition in which the electron beam 5a is irradiated from the electron beam generating apparatus 5 toward the cut surface SA.

By setting the sample angle θ of the sample 1, the irradiating angle of the electron beam 5a and the like, the electron beam 5a from the electron beam generating apparatus 5 can be irradiated on the cut surface SA. Then, the control unit 8 performs image processing on the detected signal detected by the electron detection apparatus 7 to form a cut surface image. Then, it is possible to observe a condition of the cut surface SA by the thus obtained cut surface image.

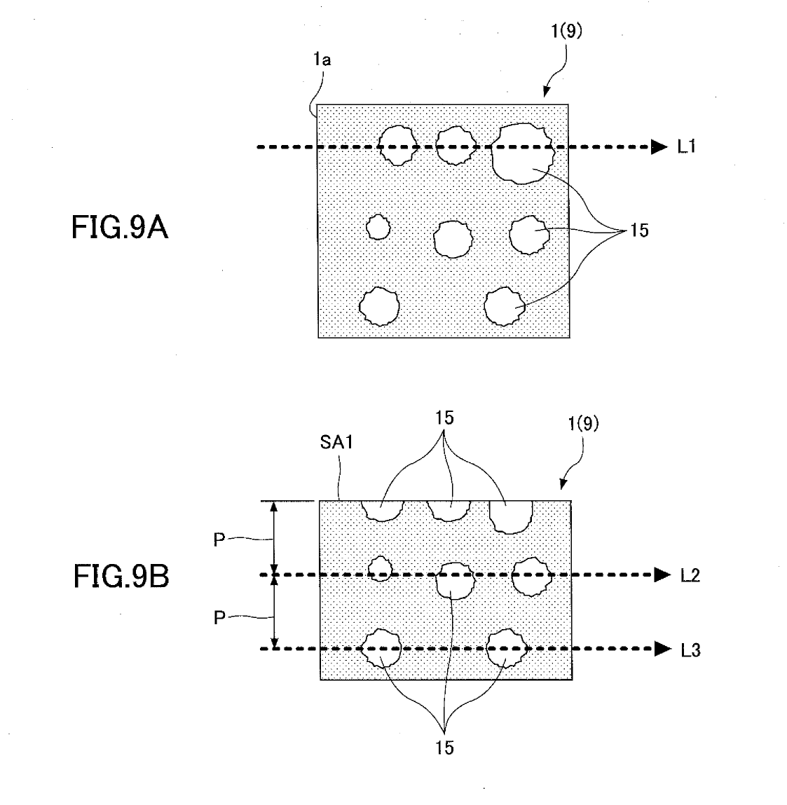

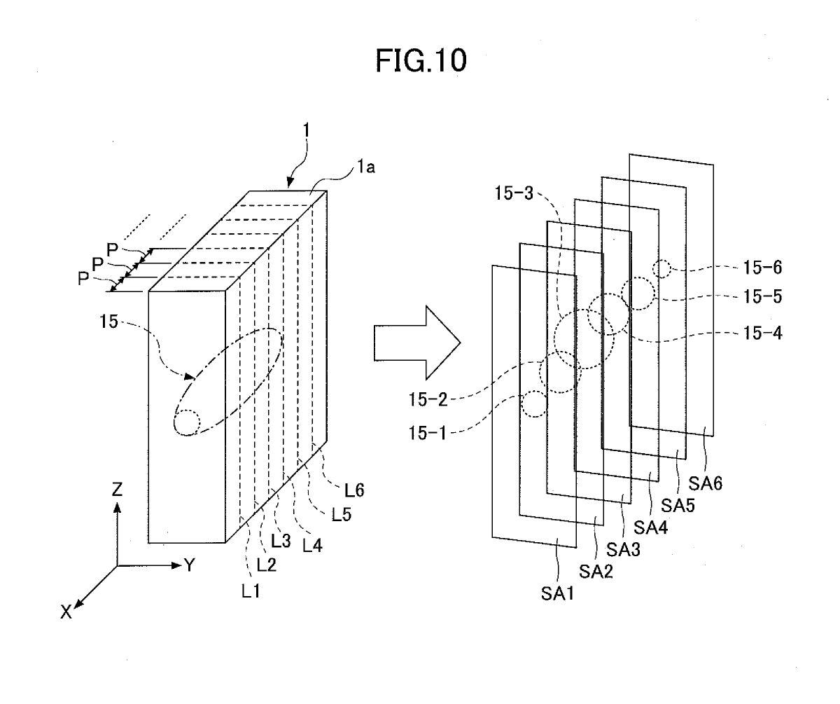

The method of cutting the sample 1 by the FIB apparatus 4 in the cutting step S3 is further explained in detail with reference to FIG. 9A, FIG. 95 and FIG. 10.

In this embodiment, the sample 1 is cut by the FIB apparatus 4. The FIB apparatus 4 is configured to be capable of arbitrarily setting a portion to be cut and capable of cutting the set portion. Specifically, as shown in FIG. 9A, the FIB apparatus 4 is capable of cutting a desired portion, which will be referred to as a cutting portion L1, of the sample 1.

As described above, conventionally, the cosmetic material film is cut with the support member (sample holder) by applying a bending stress to form a cross-section for observation. Thus, it is not possible to cut the cosmetic material film at a desired portion by the conventional method of observing a cross-section.

On the other hand, according to the method of observing the cross-section of the embodiment, when it is likely that particles 15 which are intended to be observed exist in the sample 1 at a portion at a depth D, it is possible for the FIB apparatus 4 to set the portion at the depth D as the cutting portion Ll and cut the sample 1 at the set portion to the depth D. Thus, according to the method of observing a cross-section of the embodiment, a cut surface image of the sample 1 at a desired portion can be obtained, so as to observe the cross-section of that desired portion.

Further, as described above, according to the FIB apparatus 4, the sample 1 (the cosmetic material 9) can be processed in nm order. Thus, by cutting (cross-sectioning) the sample 1 (the cosmetic material 9) by the FIB apparatus 4, after cutting the sample 1 at the cutting portion L1 as shown in FIG. 9A, the same sample 1 can be cut at different cutting portions L2, L3 and the like as shown in FIG. 9B. Further, when cutting the same sample 1 at plural cutting portions L1 to L3, the pitch P between the adjacent cutting portions L1 to L3 may be the same.

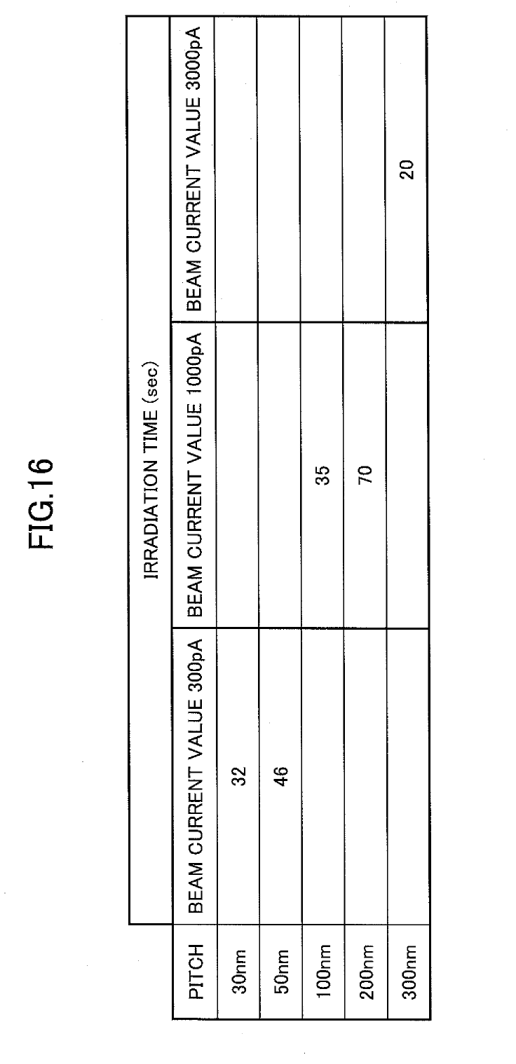

The pitch P may be arbitrarily set by controlling the beam current value and irradiation time of the FIB apparatus 4. An example is shown in FIG. 16.

When the pitch P is to be set at 30 nm, the beam current value is set as 300 pA and the irradiation time is set as 32 seconds, for example. When the pitch P is to be set at 100 nm, the beam current value is set as 1000 pA and the irradiation time is set as 35 seconds, for example. When the pitch P is to be set at 300 nm, the beam current value is set as 3000 pA and the irradiation time is set as 20 seconds, for example.

According to the method of observing a cross-section of the embodiment, the same sample 1 can be cut at plural cutting portions and cut surface images of each of the cut surfaces at the cutting portions can be obtained.

Further, a three-dimensional image of the sample 1 can be obtained by the plural cut surface images. A method of forming a three-dimensional image of the sample 1 by the plural cut surface images in the three-dimensional image processing step S5 is explained with reference to FIG. 10.

The cutting step S3 and the cut surface image processing step S4 are repeatedly performed to obtain the plural cut surface images at the different cutting portions. FIG. 10 is a schematic view showing an example where the sample 1 is cut at 6 portions, cutting portions L1 to L6. The pitch P between the adjacent cutting portions L1 to L6 is the same.

Specifically, when forming a three-dimensional image of the sample 1, the cutting step S3 using the FIB apparatus 4 is performed on the sample 1 and the sample 1 is cut at the cutting portion L1. Then the out surface image processing step S4 using the SEM 30 is performed on the cut surface SA1, which is formed at the sample 1 in the cutting step S3, to form a cut surface image of the cut surface SA1. The cut surface image of the cut surface SA1 is stored in a storing unit (not shown in the drawings) of the control unit 8.

After the cut surface image of the cut surface SA1 is stored in the control unit 8, the cutting step S3 using the FIB apparatus 4 is performed on the sample 1 again so that the sample 1 is cut at the cutting portion L2. Then, after the sample I is cut at the cutting portion L2, the cut surface image processing step S4 using the SEM 30 is performed on the cut surface SA 2 to form a cut surface image of the cut surface SA2. The cut surface image of the cut surface SA 2 is also stored in the storing unit of the control unit 8.

Subsequently, the cutting step S3 and the cut surface image processing step S4 are similarly performed on the cutting portions L3 to L6 so that cut surfaces SA3 to SA6 are respectively formed and cut surface images of the cut surfaces SA3 to SA6 can be obtained, respectively. The cut surface images of the cut surfaces SA1 to SA6 are stored in the storing unit of the control unit 8.

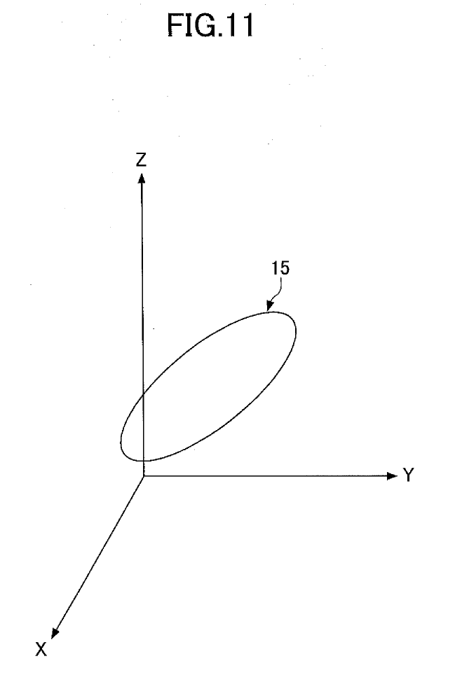

When it is assumed that a particle 15 exists in the sample 1 as shown in FIG. 10, cross-sectional images of the particle 15-1 to 15-6, corresponding to the cutting portions L1 to L6, exist in the cut surfaces SA1 to SA 6, respectively. Thus, by performing a three dimensional process based on the cut surface images stored in the storing unit of the control unit 8, a three dimensional image of the particle 15 as shown in FIG. 11 can be obtained.

Further, according to the embodiment, as the pitch P between the adjacent cutting portions among the cutting portions L1 to L6 can be set substantially the same, it is possible to accurately interpolate pixel values for the adjacent cut surface images when forming the three-dimensional image. Thus, the three-dimensional image can be accurately formed.

As described above, according to the method of observing a cross-section of a cosmetic material of the embodiment, it is possible to observe a cut surface SA at a desired cutting portion, and a three-dimensional image of the particle 15 included in the sample 1 can be obtained. Therefore, it is possible to clearly observe the particle 15.

### EXAMPLE 1

Although examples will be described in the following, the embodiment is not limited to the following examples.

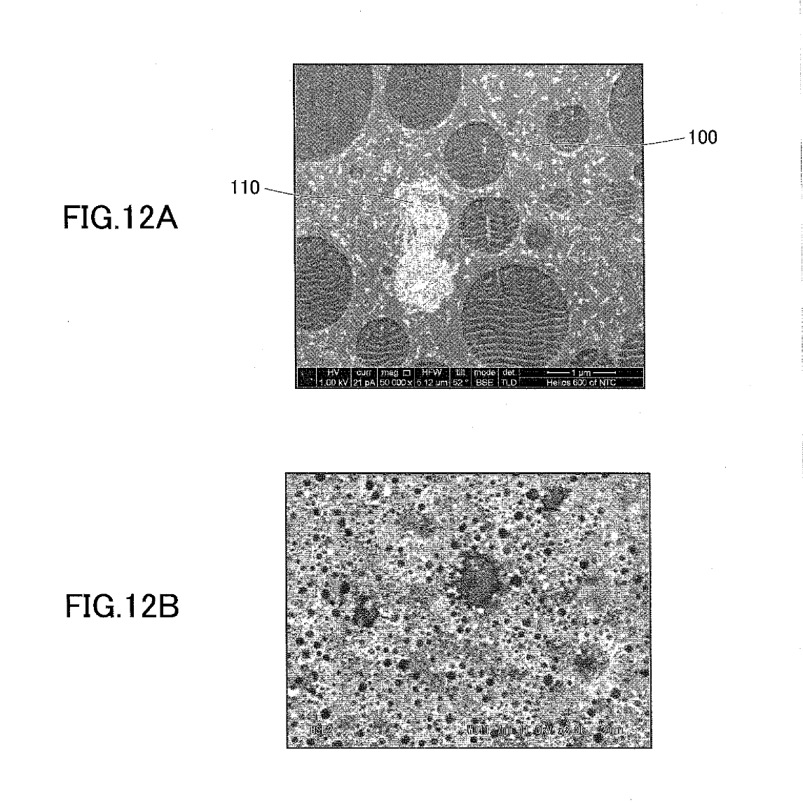

FIG. 12A and FIG. 12B are views showing a cut surface image obtained in example 1 and relative example 1, respectively. For both examples, the same sample 1, where the cosmetic material 9 is sunscreen, was used. The sunscreen includes oil, and particles and emulsified particles included in the oil.

FIG. 12A is a view showing a cut surface image obtained by cutting the sample 1 using the focused ion beam 4a by the FIB apparatus 4 (example 1). FIG. 12B is a view showing a cut surface image obtained by cutting the sample 1 using a blade instead of the FIB apparatus 4 (relative example 1).

Conditions of the sample forming step S1, the freezing step S2, the cutting step S3 and the cut surface image processing step 54 for example 1 are shown in FIG. 15. The shielding process was performed on the sample 1 between the freezing step S2 and the cutting step S3 in example 1. However, the shielding process was not performed on the sample 1 in relative example.

As shown in FIG. 12B, it is difficult to observe emulsified particles or particles in the cut surface image obtained in relative example 1. On the other hand, as shown in FIG. 12A, according to the cut surface image obtained in example 1 where the sample 1 is cut by the focused ion beam 4a, it is possible to clearly observe the emulsified particles 100 or particles dispersed in the outer oil phase. Thus, it is revealed that according to the method of observing a cross-section of a cosmetic material of the embodiment, the sample 1 is observed clearer in the two-dimensional image compared with the case using the conventional method of observing the cross-section.

### EXAMPLE 2

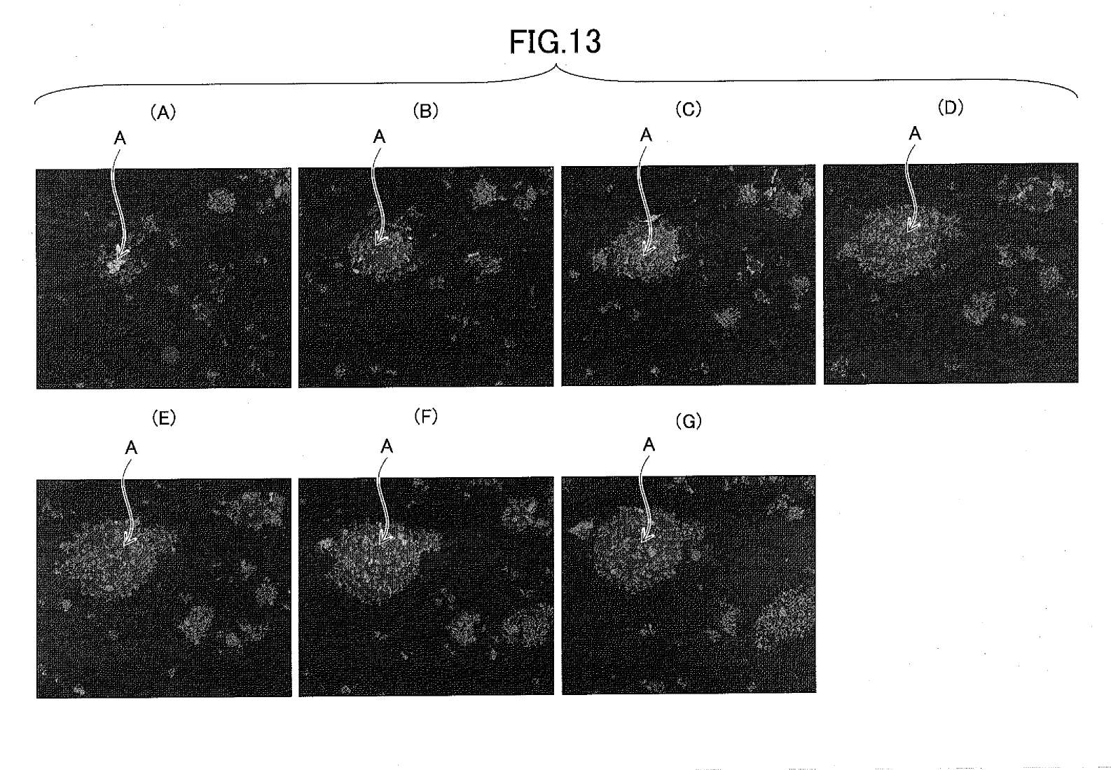

FIG. 13 shows cut surface images (A) to (G) of a preparation including emulsified particles obtained by the method of observing a cross-section of a cosmetic material of the embodiment. Conditions of the sample forming step S1, the freezing step S2, the cutting step S3, the cut surface image processing step S4 and the three-dimensional image processing step S5 for example 2 are shown in FIG. 15.

The cut surface images (A) to (G) shown in FIG. 13 are in a relationship similar to the cut surface images of the cut surfaces SA1 to SA6 shown in FIG. 10 (7 cut surface images are shown in FIG. 13 although 6 cut surface images are shown in FIG. 10). The seven cut surface images (A) to (G) are images obtained by cutting the sample 1 with a predetermined pitch such as 100 nm or the like in the cutting step S3.

In the cut surface images (A) to (G), a particle dispersed in the oil phase is shown by an arrow “A”. The cut surface images (A) to (G) are stored in the storing unit of the control unit 8 as image data. Then, by performing a three-dimensional process for the cut surface images (A) to (G) by using imaging software or the like, a three-dimensional image (3D image) of particles included in the sample 1 was obtained. For the imaging software in this example, Amira 3.1.1 of Visage Imaging Inc. was used, as shown in FIG. 15.

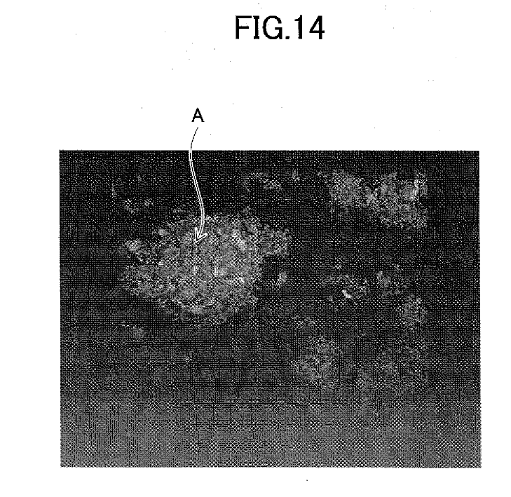

FIG. 14 is a view showing a three-dimensional image of the particles included in the sample 1 obtained by the above described method. According to the example, as the sample 1 is cut with an even pitch of 100 nm in the cutting step S3 and the cut surface images with a high resolution are formed in the cut surface image processing step S4, the three-dimensional image with a high resolution can be formed based on the cut surface images in the three-dimensional image processing step S5. Thus, the status of the mixtures such as particles included in the sample 1 (cosmetic material 9) can be clearly observed.

According to the method of observing a cross-section of a cosmetic material, a frozen sample is processed with a focused ion beam capable of processing in nano-meter order to form a cut surface, a cut surface image of the cosmetic material at a desired portion can be obtained.

It is described that the sample 1 is shielded with a shielding process after the sample 1 is frozen in the freezing step S2 and the sample 1 is conveyed to the subsequent apparatus in a shielded manner. Alternatively, the freezing step 2 may be performed in a same apparatus as that performing the cutting step S3 and the cut surface image processing step S4, such as the FIB-SEM 20. In such a case, as the shielding process can be omitted.

Although a preferred embodiment of the method of observing a cross-section of a cosmetic material has been specifically illustrated and described, it is to be understood that minor modifications may be made therein without departing from the sprit and scope of the invention as defined by the claims.

The present invention is not limited to the specifically disclosed embodiments, and variations and modifications may be made without departing from the scope of the present invention.

The present application is based on Japanese Priority Application No. 2011-186537 filed on Aug. 29, 2011, the entire contents of which are incorporated herein by reference.

What is claimed is:

1. A method of observing a cross-section of a cosmetic material, comprising:
a sample forming step of forming a sample by providing a cosmetic material on a sample holder;
a freezing step of freezing the sample;
a cutting step of forming a cut surface on the sample by processing the frozen sample by a focused ion beam; and
a cut surface image processing step of obtaining a cut surface image of the cut surface using a scanning electron microscope.

2. The method according to claim 1,
wherein the cutting step and the cut surface image processing step are repeatedly performed on the sample to obtain plural of the cut surface images of the cut surfaces at different cutting portions, respectively, and
the method further comprises;
an image processing step of generating a three-dimensional image of the sample by image processing the plural cut surface images.

3. The method according to claim 1,
wherein in the freezing step, the frozen sample is shielded while being kept frozen, and
the cutting step and the cut surface image processing step are performed on the sample which is kept frozen.

4. The method according to claim 1,
wherein the sample holder is an artificial skin, a resin tape, or a skin fragment.

5. The method according to claim 1, further comprising:
an evaporating step of forming an evaporated metal film on the cut surface after performing the cutting step and before performing the cut surface image processing step.
